(19) United States
(12) Patent Application Publication
(10) Pub. No.: US 2008/0288541 A1
(43) Pub. Date: Nov. 20, 2008

(54) Method, Process, Schema, and Apparatus to Organize and Manage Company Folksonomy

(76) Inventor: Luca Venturini, Rome (IT)

Correspondence Address: WHITE-WELKER & WELKER, LLC, P.O. BOX 199, CLEAR SPRING, MD, 21722-0199, US

(21) Appl. No.: 12/120,657

(22) Filed: May 15, 2008

Related U.S. Application Data
(60) Provisional application No. 60/917,934, filed on May 15, 2007.

(51) Int. Cl. G06F 17/30

(52) U.S. Cl. 707/104.1; 707/E17.009

(57) ABSTRACT

A method, a process, and a schema that will be used to organize and manage a double-entry company accounting system, and a software system that is provided to allow a computer to manage that method, process and schema. The schema includes: account tagging of the accounting system of the company, including customer and vendor account tagging, product tagging, and capital asset tagging; transaction tagging; and tag cloud reports describing the system at or within a given time period. Tag cloud movies represent the changing situation of the company accounting system.

### CROSS REFERENCE TO RELATED APPLICATIONS

This application claims priority from U.S. Provisional Patent Application Ser. No. 60/917934, entitled “Method, Process, Schema, and Apparatus to Organize and Manage Company Folksonomy”, filed on 15 May 2007.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a method for organizing and managing a double-entry company accounting system. More specifically, the present invention relates to a method for organizing and managing a double-entry company accounting system including tagging of the accounting system.

### BACKGROUND OF THE INVENTION

A tag cloud is a visual depiction of the content tags used on a website. Often, frequently used tags are depicted in a larger font or otherwise emphasized, and the displayed order is generally alphabetical. This makes it much easier to find a tag by either alphabet or by popularity. Selecting a single tag within a tag cloud will usually lead to a collection of items associated with that tag.

In record keeping, particularly accountancy, the double-entry accounting system is the basis of the standard system used by businesses and other organizations to record financial transactions. Its premise is that a business's (or other organization's) financial condition and results of operations are best represented by several variables, called accounts, each of which reflects a particular aspect of the business as a monetary value.

Every transaction is recorded by entries in at least two accounts. The total of the debit values must equal the total value of the credit values. The premise for this is that any monetary transaction must logically affect two aspects of a company.

A working document called trial balance is created which lists all the balances from all the accounts in the ledger. The amounts are copied to a two-column list with debit balance amounts recorded in the left column and credit balance amounts recorded in the right column. This list contains each account's value at the date of the Trial Balance (e.g. month end date), and each account is listed to ensure that the total of all the debit account balances (left column) equals the total of all the credit account balances (right column).

Financial statements are drawn from the trial balance, which may include: the income statement; the balance sheet; the cash flow statement; and the Statement of retained earnings.

### SUMMARY OF THE INVENTION

The present invention teaches a patent to a method, a process, and a schema that will be used to organize and manage a double-entry company accounting system, and to patent a software that will be built to allow a computer to manage that method, process and schema. The schema includes: account tagging of the accounting system of the company, including customer and vendor account tagging, product tagging, and capital asset tagging; transaction tagging; and tag cloud reports describing the system at or within a given time period. Tag cloud movies represent the changing situation of the company accounting system.

### DEFINITIONS

In this application, the term “company” is used to refer to every and all institutions that manage a double-entry accounting system, including but not confined to the following: company, corporation, state, government, institution, non profit organization, professional organization, person, or any other subject using a double-entry accounting system. This includes institutions composed of more than one of the above organizations.

Whenever the term “tag cloud” is used in this document, it can refer either to a tag cloud made up of tags sized according to the value of the items in that tag or to a tag cloud made up of tags sized according to the number of items having that tag.

The method of the present invention may also be referred to as “Company Folksonomy”. Additionally, this document will use AR, AP and GL instead of Account Receivable, Account Payable and General Ledger.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a “Folksonomy” Tag Cloud as taken on a specific date and time;

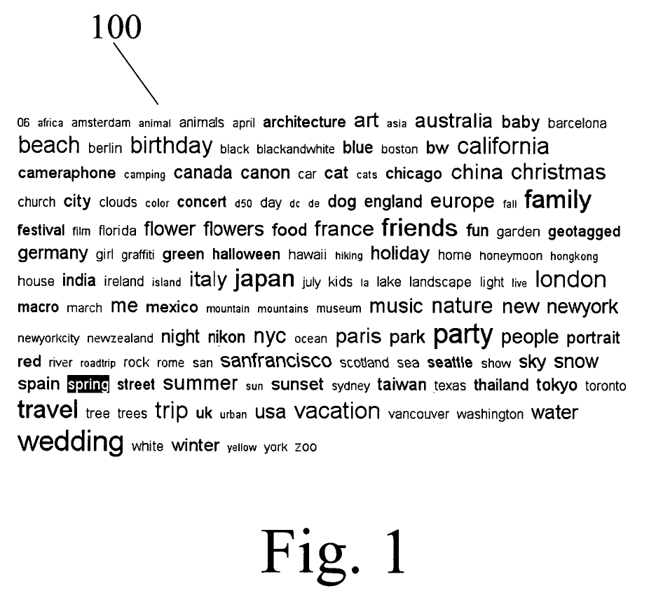

FIG. 2 illustrates Tag Cloud of the trial balance of an Italian company;

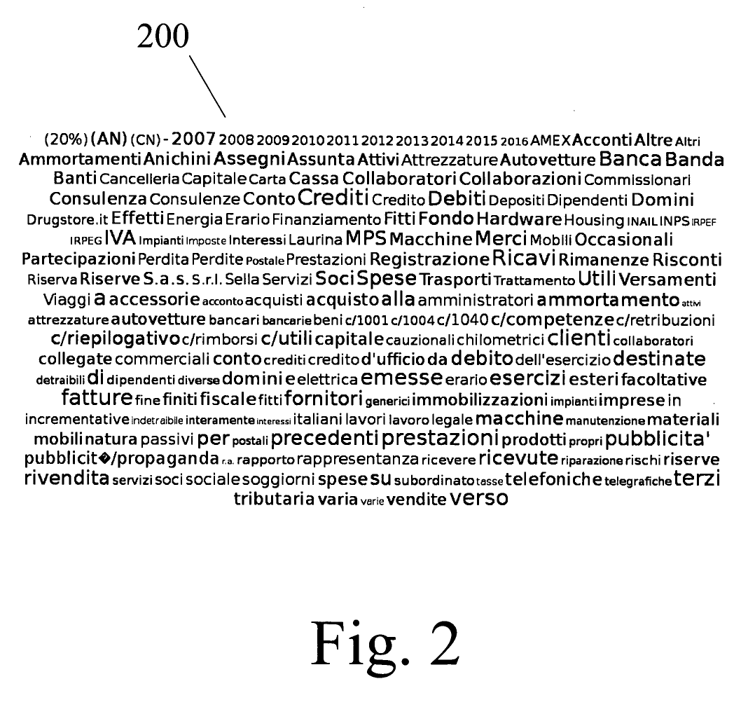

FIG. 3 illustrates an Aggregate Balance Sheet Cloud; and

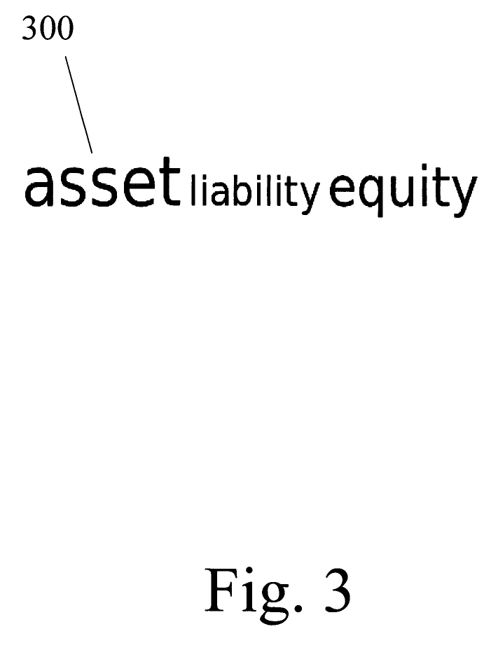

FIG. 4 is a flow chart of the logic diagram of the present invention.

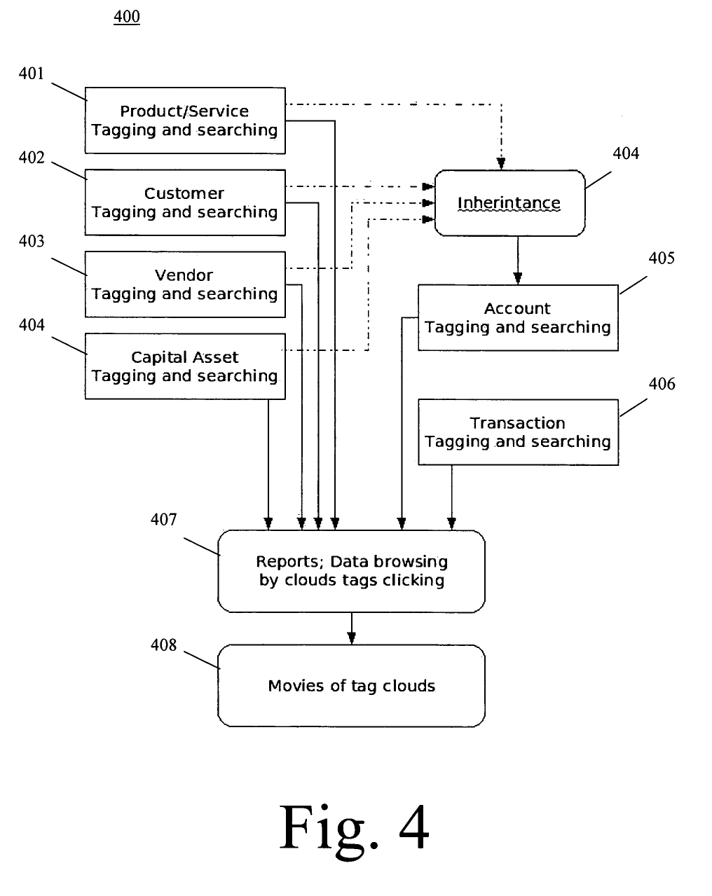

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Now referring to Figures, the embodiment of the present invention is illustrated. Each part, assembly of parts, or service that the company can sell, produce or buy will be tagged with as many tags as required. Referring to the figures, it is possible to see the various major elements constituting the apparatus of the present invention. The present invention teaches a patent to a method, a process, and a schema that will be used to organize and manage a double-entry company accounting system, and to patent a software that will be built to allow a computer to manage that method, process and schema. The schema 400 includes: account tagging 405 of the accounting system of the company, including customer and vendor account tagging 402 and 403, product tagging 401, capital asset tagging 404; transaction tagging 406; and tag cloud reports 408 describing the system at or within a given time period. Tag cloud movies 408 represent the changing situation of the company accounting system.

Tags clouds 100 are typically represented using inline HTML elements. The tags can appear in alphabetical order, in a random order, they can be sorted by weight, and so on. Some prefer to cluster the tags semantically so that similar tags will appear near each other. Heuristics can be used to reduce the size of the tag cloud whether or not we are trying to cluster the tags.

Tags for product searching 401 will be used to search for parts, assembly of parts, and services; a tag search will find any set of items attached to a given tag. Tag searching 401 can be used whenever a user needs to find an object in the accounting system. Product tags 401 will be inherited 404 by the inventory accounts as explained below.

Accounts are tagged 405 and split into six different types: Asset, Liability, Equity, Income, Expense, and Transitory. One account can belong to one, and only one, of the six types. In addition, accounts can be tagged with as many tags as required. Each tag can be customized to describe the information contained in the tagged accounts.

Inheritance 404 means that the account 405 will have its own tags as well as the tags belonging to, or “inherited,” from any other item brought into or contained within that group. The following groups of accounts will contain both tags from the account and tags inherited from the items contained within it: AR accounts 405 and selling accounts 405 inherit customer tags 402; AP accounts 405 and buying accounts 405 inherit vendor tags 403; Inventory accounts 405 inherit product tags 401; and Capital asset accounts 405 inherit asset tags 404.

Each customer and vendor within the system will be tagged with as many tags as required by the user, in the same way that accounts are tagged. Tagging a customer 402 or vendor 403 will also be reflected in the tags of the accounts 405 related to that contact.

Customer sales and AR are accounts related to a customer. Both those accounts will be tagged with the customer's tags 402. Therefore tagging a customer will also tag both those accounts.

The same will hold true for vendors: expenses related to a vendor and AP related to a vendor will be tagged with the tags of the vendor, and tagging a vendor 403 will also tag both of these accounts.

Customer tagging 402 and vendor tagging 403 can also be used to help in the process of customer and vendor searching.

Each capital asset of the company will be tagged 404 with as many tags as required. The value of the capital assets of the company at any given time will be represented as a tag cloud, as described below.

Tags can be used to search for accounts 405. A tag search will produce all of the accounts containing that tag. This set may be void (no result), may contain only one transaction, or more generally, may contain many transactions.

The trial balance cloud 200 will contain all the tags of the company at a given time period, using two different colors, each indicating whether the total balance of the account is in a debit or credit position. The trial balance cloud 200 can also be split into two different clouds made up of debit and credit.

There are different ways to view the balance sheet of a company at a given date: aggregate balance sheet cloud 300; assets cloud; liability cloud; equity cloud; AR cloud; AP cloud; inventory cloud; capital asset cloud; and overall analytic balance sheet cloud.

The aggregate balance sheet cloud 300 is represented by three words. The size of each word reflects the size of the balances of the accounts contained in that group. Clicking on one of the three words in this cloud will produce the tag clouds associated with each topic.

The AR cloud will be represented as the cloud of the customer's tags, each tag multiplied by the balance of the AR related to each customer. Clicking on a tag will produce: a list of all outstanding AR entries for the customers with that tag, and the list of the all customers having that tag.

The AP cloud will be represented as the cloud of the vendor's tags, each tag multiplied by the balance of the AP related to each vendor. Clicking on a tag will produce: the list of all outstanding AP entries for the vendors having that tag, and the list of all vendors having that tag.

The inventory cloud in a given moment will be represented as the cloud of the tags of the inventory items existing at that moment. The size of each tag can be reflective of either the value of the item or of the number of items in inventory at a given moment. Different valuation methods of the inventory items (LIFO, FIFO, average, etc) will produce different tag clouds. Clicking on a tag in the inventory cloud will give the list of all products attached to that tag.

The capital asset cloud represents the value of the capital assets of the company at any given moment. Clicking on a tag of the capital asset cloud will give the list of all capital assets attached to that tag.

The assets, liability and equity clouds will be represented as clouds of all the tags of all the accounts in those respective groups. In these reports, AR, AP, inventory and capital assets will each be represented by clouds inside the respective larger clouds. Tags will be viewed in different colors according to whether the balance of the account is in a state of credit or debit. Clicking on a tag will give: a list of all accounts having that tag, and a list of all account entries that make up the value given in the tag.

The overall analytic balance sheet cloud is represented as the aggregate of the assets, liability and equity clouds. Different colors are used for credit and debit, and different positions in the cloud are used for assets, liability or equity respectively. Six different colors can ultimately be used in a cloud. Clicking on a tag will give: a list of all accounts having that tag, and a list of all account entries that make up the value given in the tag.

The income statement is a report related to a given period of time. The income statement contains accounts belonging to two groups: income and expenses. The income statement cloud will be represented as: a cloud in two colors, representing income and expenses, or two different clouds for income and expenses.

The profit or loss of a given period can be seen either as the terms “profit” and “loss,” or as the symbols “+” and “−”, with the size of each reflective of the profit or loss value. Clicking a tag in the income statement cloud will give: a list of all the accounts having that tag and a list of all account entries that make up the value given in the tag.

Each transaction is managed by being labeled as belonging to one, and only one, of the following five categories: AR invoices, AR payments, AP invoices, AP payments, General Ledger.

Each transaction 406 can be tagged with as many tags as required by the user, and the following pre-displayed tags will aid the user in choosing tags for each transaction: the tags of all accounts involved in the transaction; the tags of the customer or vendor of the transaction (only AR or AP transactions); and the tags of the service or part sold or bought (only AR or AP transaction).

Useful examples of transaction tagging methods include: transactions belonging to projects, transactions involving sellers, transactions involving accounting employees, transactions involving a country, or transactions involving an office. This can include a combination of those methods too. For example, an invoice can be tagged as “Denver-Jack-Deal-DakarProject”, representing place-person-subject-project.

Tags can be used to search for transactions 406. A tag search will produce a set of all transactions attached to that tag. This set may be void (no result), may contain only one transaction, or more generally, may contain many transactions. Transaction tagging 406 will introduce many more layers to the company accounting system.

Selecting a subset of the company transaction tags 406, even one tag, will give a complete balanced sub-company accounting system that can be viewed, browsed, or reported in the same way as the whole company.

Bookkeeping software and all other methods described in this document can be used on both a company and a sub-company. Projects, sellers, employees, countries, offices are all examples of sub-companies.

Different tag clouds in different moments of time or in different periods of time can be represented as movies of changing tag clouds 408.

The trial balance cloud 200 and each balance sheet clouds described above (aggregate balance sheet cloud 300, assets cloud, liability cloud, equity cloud, AR cloud, AP cloud, inventory cloud, capital asset cloud, and overall analytic balance sheet cloud) are each descriptive of a specific moment in time.

These clouds change from time to time, so the various clouds, each representing a period of time, can be strung together like the frames of a movie and viewed as a movie, with each frame representing a different period of time (eg.: a day). Like clouds, cloud movies 408 can represent the number of items with each tag, or the balance value of the items with each tag.

The income statement movies will be different from the other movies. Two different kinds of income statement movies can be represented: setting a time-window period (eg. 1 week), will build the cloud movie using the income sheet clouds for that week. When the movie plays, each frame will represent a time period within that week; or setting an overall period (eg. 1 year), will build the cloud movie from the start of the period up to the end of the period.

Although objects can be manually tagged by the user with information on the location, each customer or vendor can also be automatically geo-tagged using the location data extracted from the address. Country, state, city or zip code can be used to automatically produce location tags for each customer or vendor.

In multi user software environments, every time the user chooses to attach the tag to an object, pre-displayed examples from the tagging schema of other users can be used to help maintain uniformity.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method to organize, manage and search data in an accounting system providing the steps of
providing tags that can be logically attached to each account, each customer, each vendor, each product, each service, and each capital asset of a company; and
attaching said tags to each account, each customer, each vendor, each product, each service, and each capital asset of a company.

2. The method of claim 1 further comprising the step of attaching a tag to every transaction in the company.

3. The method of claim 1 further comprising the step of
generating one or more sub-accounting systems from a given accounting system by selecting and using one or more of the tags describing the base accounting system.

4. The method of claim 1 further comprising the steps of
organizing customers and vendors of a company;
managing customers and vendors of a company; and
searching customers and vendors of a company.

5. The method of claim 1 further comprising the steps of
organizing the items, assembly, and services of a company;
managing the items, assembly, and services of a company; and
searching the items, assembly, and services of a company.

6. The method of claim 1 further comprising the steps of
organizing the inventory of a company;
managing the inventory of a company; and
searching the inventory of a company

7. The method of claim 1 further comprising the steps of
organizing the capital assets of a company;
managing the capital assets of a company; and
searching the capital assets of a company.

8. The method of claim 1 further comprising the steps of
determining a trial balance cloud
determining an aggregate balance sheet cloud;
determining an assets, liability and equity cloud;
determining an AR and AP cloud;
determining an inventory cloud;
determining a capital asset cloud;
determining an overall analytic balance sheet cloud; and
determining an income statement cloud.

9. The method of claim 8 wherein different tag clouds in different moments of time or in different periods of time can be represented as movies of changing tag clouds.

10. The method of claim 9 further comprising the steps of
determining a trial balance cloud movie;
determining an aggregate balance sheet cloud movie;
determining an assets, liability and equity cloud movies;
determining an AR and AP cloud movies;
determining an inventory cloud movie;
determining a capital asset cloud movie;
determining an overall analytic balance sheet cloud movie; and
determining an income statement cloud movie.

11. The method of claim 8 or 9 further comprising the steps of organizing each cloud by either value or count.

12. The method of claim 1 wherein accounts are split into six different types: Asset, Liability, Equity, Income, Expense, and Transitory.

13. The method of claim 12 wherein accounts
AR accounts and selling accounts inherit customer tags;
AP accounts and buying accounts inherit vendor tags;
Inventory accounts inherit product tags; and
Capital asset accounts inherit asset tags.

14. The method of claim 8 wherein the trial balance cloud
contains all the tags of the company at a given time period,
uses two different colors, each indicating whether the total balance of the account is in a debit or credit position; and
said trial balance cloud is split into two different clouds made up of debit and credit.

15. The method of claim 8 wherein the aggregate balance sheet cloud is
represented by three words;
the size of each word reflects the size of the balances of the accounts contained in that group; and
selecting one of the three words in this cloud will produce the tag clouds associated with each topic.

16. The method of claim 1 wherein each customer or vendor is automatically geo-tagged using the location data extracted from the address.
